(19) United States
(12) Patent Application Publication
(10) Pub. No.: US 2013/0315806 A1
(43) Pub. Date: Nov. 28, 2013

(54) SYSTEM FOR PRE-TREATING MALODOROUS SUBSTANCES IN POLLUTION CONTROL FACILITY

(71) Applicants: Kwang Mo Seong, Bucheon (KR); Ga Yean Yang, Pohang (KR); Hyo Yeong Cheong, Ulsan (KR); Joon Soo Choi, Ulsan (KR)

(72) Inventors: Kwang Mo Seong, Bucheon (KR); Ga Yean Yang, Pohang (KR); Hyo Yeong Cheong, Ulsan (KR); Joon Soo Choi, Ulsan (KR)

(73) Assignees: KIA MOTORS CORPORATION, Seoul (KR); HYUNDAI MOTOR COMPANY, Seoul (KR)

(21) Appl. No.: 13/590,346

(22) Filed: Aug. 21, 2012

(30) Foreign Application Priority Data
May 23, 2012 (KR) 10-2012-0055042

(51) Int. Cl. B01D 53/78

(52) U.S. Cl. 423/210; 422/168

(57) ABSTRACT

Provided is a system for pre-treating malodorous substances in a flushing pollution control facility, in which air polluted in a stage before the flushing pollution control facility is oxidized to decompose a gaseous pollution substance in the air, and then the gaseous pollution substance in absorbing liquid is oxidized, such that the malodor gathering capability of the absorbing liquid is improved, thereby enhancing the malodor removing efficiency of the flushing pollution control facility. To this end, the present invention provides a system for pre-treating malodorous substances in a flushing pollution control facility, the system including an oxidizer generating device for generating oxidizing water comprising an oxidizer, a turbulent flow forming device for forming a turbulent flow in exhaust gas introduced to the flushing pollution control facility, and an oxidizer spray device supplied with oxidizing water from the oxidizer generating device to spray the oxidizing water in an atomized form to the exhaust gas which flows in a turbulent flow state to the flushing pollution control facility, in which the exhaust gas is primarily oxidized by the oxidizer included in the oxidizing water sprayed to the exhaust gas, and absorbing liquid of the flushing pollution control facility is secondarily oxidized by the non-reacted oxidizer to decompose malodorous substances, thereby improving malodor removing efficiency.

### TECHNICAL FIELD

The present disclosure relates to a system for pre-treating malodorous substances in a flushing pollution control facility. More particularly, it relates to a system for pre-treating malodorous substances in a flushing pollution control facility, in which air polluted in a stage before the flushing pollution control facility is oxidized to decompose a gaseous pollution substance in the air, and then the gaseous pollution substance in absorbing liquid is oxidized, such that the malodor gathering capability of the absorbing liquid is improved, thereby enhancing the malodor removing efficiency of the flushing pollution control facility.

### BACKGROUND ART

Generally, a flushing pollution control facility simultaneously removes particulates and gaseous pollution substances included in the air, such that it has been widely used as a post-treating facility in a core manufacturing process, a molten metal injection process, a de-molding process, and so forth of a casting factory where a lot of casting particulates and malodor (phenol, amines, etc.) are generated.

Examples of the flushing pollution control facility may include a wet-type electric dust collector, a scrubber, and so forth.

FIG. 1 is a schematic diagram showing a structure of a scrubber. A general scrubber 10 includes porous pall rings 5 installed in a multi-step form in a chamber 2 which receives a specific quantity of absorbing liquid, spray nozzles 7 installed on an upper portion of the pall rings 5, a pump 3 for pumping the absorbing liquid received in the chamber 2 and supplying the absorbing liquid to the spray nozzles 7, and a demister 8 installed above the spray nozzles 7 to prevent minute absorbing liquid particles generated by the spray nozzles 7 from being exhausted to the outside air together with treated clean air.

The operating state of the scrubber will be described below.

The polluted air, upon introduced through an inlet 1 in a lower portion of the chamber 2, passes through through-holes of support plates 4, and moves toward an outlet 9 in an upper portion of the chamber 2. In this state, the absorbing liquid stored in the bottom of the chamber 2 is supplied by the pump 3 to the spray nozzles 7 through a pipe 6.

The spray nozzles 7 spray the supplied absorbing liquid to the polluted air, such that the sprayed absorbing liquid contacts particulates and gaseous pollution substances, thereby removing the particulates and gaseous pollution substances from the air.

A contact time between the polluted air and the absorbing liquid is guaranteed by the pall rings 5. As the air and the absorbing liquid flow along an empty space of the pall rings 5, a flow path is changed, such that the absorbing liquid can contact the polluted air for a long time and thus the pollution substance removing efficiency can be improved.

Moreover, as the porous pall rings 5 are installed in the multi-step form in the chamber 2, the pollution substance removing efficiency can be further enhanced.

However, in the conventional scrubber 10, when the absorbing liquid is used for a long time, the concentration of particulates in the absorbing liquid increases, which fills the spray nozzles, such that proper absorbing liquid spraying becomes difficult to achieve, degrading the efficiency in removing the particulates and the gaseous pollution substances. Furthermore, as the gaseous pollution substances in the absorbing liquid are over-saturated, the removing efficiency is degraded. For this reason, the absorbing liquid needs to be disposed periodically (e.g., daily).

If a waste water disposal plant is provided, the disposed absorbing liquid (waste liquid) is periodically transferred to and treated in the waste water disposal plant, and due to a short replacement period, the cost of water and waste water treatment increases.

In addition, if any waste water disposal plant is not provided, the waste liquid is entrusted for treatment at some expense. In this case, to cut the cost, the absorbing liquid is used for a long time (3 through 6 months), degrading the efficiency in removing the particulates and the gaseous pollution substances and thus increasing the enmity of local residents for the malodor.

### CONTENTS OF THE INVENTION

### Objects to be Solved

The present invention has been made in an effort to solve the above-described problems associated with prior art, and provides a system for pre-treating malodorous substances in a flushing pollution control facility, in which an oxidizer is supplied to polluted air introduced to the flushing pollution control facility in a stage before the flushing pollution control facility to primarily oxidize a gaseous pollution substance in the air and decompose the gaseous pollution substance in the air, and then the gaseous pollution substance in absorbing liquid is secondarily oxidized through the non-reacted oxidizer to improve the malodor gathering capability of the absorbing liquid, thereby improving the malodor removing efficiency of the flushing pollution control facility.

### Means for Achieving the Objects

In one aspect, the present invention provides a system for pre-treating malodorous substances in a flushing pollution control facility, the system including an oxidizer generating device for generating oxidizing water comprising an oxidizer, a turbulent flow forming device for forming a turbulent flow in exhaust gas introduced to the flushing pollution control facility, and an oxidizer spray device supplied with oxidizing water from the oxidizer generating device to spray the oxidizing water in an atomized form to the exhaust gas which flows in a turbulent flow state to the flushing pollution control facility, in which the exhaust gas is primarily oxidized by the oxidizer included in the oxidizing water sprayed to the exhaust gas, and absorbing liquid of the flushing pollution control facility is secondarily oxidized by the non-reacted oxidizer to decompose malodorous substances, thereby improving malodor removing efficiency.

More specifically, the oxidizer generating device includes a water quantitative supply device for supplying a specific quantity of water, a hydrogen peroxide quantitative supply device for supplying a specific quantity of hydrogen peroxide, a mixing device supplied with the water and the hydrogen peroxide from the water quantitative supply device and the hydrogen peroxide quantitative supply device, respectively to mix the water and the hydrogen peroxide, and an ultrasonic wave reacting device for reacting the mixture liquid introduced from the mixing device with ultrasonic waves, in which the hydrogen peroxide in the mixture liquid is transformed into an oxidizer by the ultrasonic waves to generate the oxidizing water.

The ultrasonic wave reacting device includes a reaction vessel for receiving the mixture liquid exhausted and supplied from the mixing device, an ultrasonic wave generating device for generating the ultrasonic waves, an ultrasonic wave rod for delivering the ultrasonic waves generated in the ultrasonic wave generating device to the mixture liquid in the reaction vessel, and an oxidizing water storing vessel supplied with the oxidizing water generated by reacting the mixture liquid in the reaction vessel with the ultrasonic waves to temporarily store the oxidizing water.

The oxidizer spray device includes an oxidizing water quantitative pump for feeding a specific quantity of oxidizing water from the oxidizing water storing vessel, a compressed air supply device for supplying compressed air, and oxidizing water spray nozzles supplied from the oxidizing water fed from the oxidizing water quantitative pump by the compressed air supplied from the compressed air supply in device to atomize the fed oxidizing water and spray the atomized oxidizing water to the exhaust gas.

The turbulent flow forming device includes a gas pipe in which at least one impellers are installed.

### Effects of the Invention

By applying the system for pre-treating malodorous substances according to the present invention to the conventional flushing pollution control facility, the malodorous substances in the exhaust gas are primarily oxidized and the malodorous substances in the absorbing liquid are secondarily oxidized to improve the malodor gathering capability of the absorbing liquid, thereby enhancing the malodor removing efficiency of the flushing pollution control facility.

By enhancing the conventional flushing pollution control facility with the system for pre-treating malodorous substances according to the present invention, the malodor gathering capability of the absorbing liquid is maintained with reduction of the concentration of organic materials in the absorbing liquid, such that a period of use of the absorbing liquid is extended, cost reduction is possible, and proper treatment of the gaseous pollution substance is achieved, thereby preventing the enmity of local residents for the malodor.

### BRIEF DESCRIPTION OF THE DRAWINGS

FIG. 1 is a schematic diagram showing a scrubber of a flushing pollution control facility;

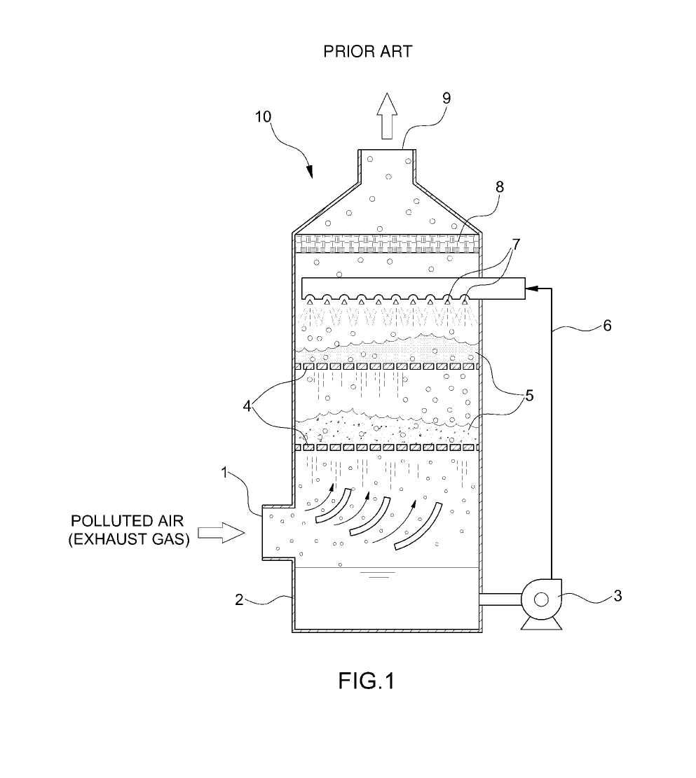

FIG. 2 is a schematic diagram showing a system for pre-treating malodor substances in a flushing pollution control facility according to the present invention; and

FIG. 3 is a structural diagram showing an oxidizer generating device and an oxidizer spray device of a system for pre-treating malodor substances according to the present invention.

### DETAILED DESCRIPTION OF THE INVENTION

Hereinafter, an exemplary embodiment of the present invention will be described in detail with reference to the accompanying drawings to allow those of ordinary skill in the art to easily carry out the present invention. While the invention will be described in conjunction with the exemplary embodiment, it will be understood that present description is not intended to limit the invention to the exemplary embodiment. On the contrary, the invention is intended to cover not only the exemplary embodiment, but also various alternatives, modifications, equivalents and other embodiments, which may be included within the spirit and scope of the invention as defined by the appended claims.

Hereinafter, an exemplary embodiment of the present invention will be described in detail with reference to the accompanying drawings.

The present invention provides a system for pre-treating a malodorous substance in a flushing pollution control facility, in which of polluted air (hereinafter, ‘exhaust gas’) exhausted from a process such as a molten metal injection process in a stage before a scrubber, a gaseous pollution substance (hereinafter, a malodorous substance), which is the main cause of malodor, is primarily oxidized and thus is decomposed, and the non-reacted oxidizer secondarily oxidizes and thus decomposes the malodorous substance in the absorbing liquid in the scrubber, thereby improving the malodor gathering capability of the absorbing liquid and thus improving the malodor removing efficiency of the flushing pollution control facility.

Therefore, in the present invention, an oxidizer generating device, an oxidizer spray device, and a turbulent flow forming device are connected to a conventional flushing pollution control facility, thereby supplying an oxidizer to exhaust gas introduced to the flushing pollution control facility.

The system for pre-treating a malodorous substance in a flushing pollution control facility according to the present invention generates oxidizing water including an oxidizer (.OH) by using the oxidizer generating device and sprays the oxidizing water generated by the oxidizer generating device to the exhaust gas supplied to the scrubber for injection. In this state, the turbulent flow forming device is used to in cause the exhaust gas supplied to the scrubber to form a turbulent flow, such that the exhaust gas and the oxidizer are mixed to primarily decompose a malodorous substance in the exhaust gas and secondarily decompose the malodorous substance in the absorbing liquid, thereby improving the malodor removing efficiency of the flushing pollution control facility in a dual-oxidizing manner.

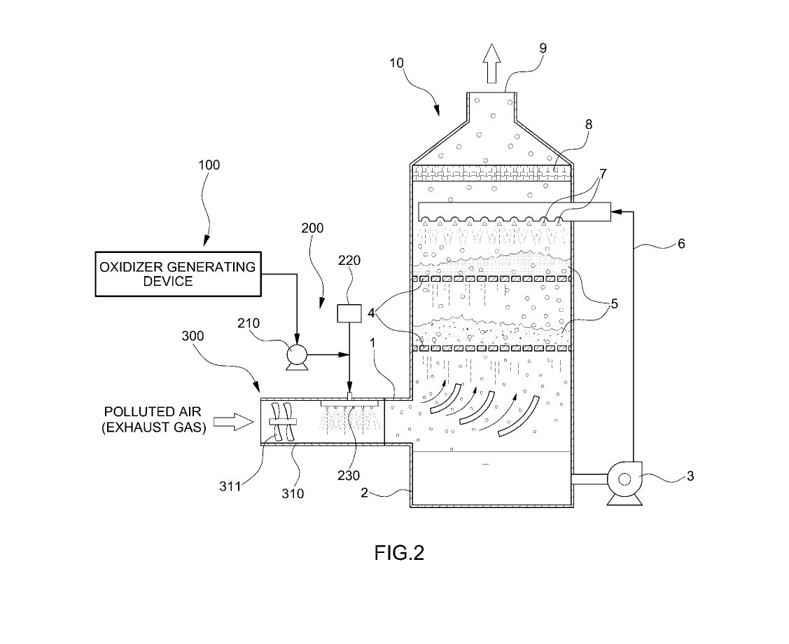

To this end, in the present invention, as shown in FIG. 2, in a stage before the scrubber 10, an oxidizer generating device 100, an oxidizer spray device 200 for receiving oxidizing water from the oxidizer generating device 100 and spraying the oxidizing water to the exhaust gas introduced to the scrubber 10, and a turbulent flow forming device 300 for forming a turbulent flow in the exhaust gas supplied to the scrubber 10 are installed.

Referring to FIG. 2, the exhaust gas supplied to the scrubber 10 first passes through the turbulent flow forming device 300 to form a turbulent flow, and when the exhaust gas moves along a pipe in a turbulent flow state, oxidizing water (including an oxidizer) generated in the oxidizer generating device 100 is sprayed in an atomized state by the oxidizer spray device 200, such that the exhaust gas is introduced to the scrubber 10 in a state where the malodorous substances thereof are decomposed and reduced.

The non-reacted oxidizer (.OH) of the atomized oxidizing water introduced to the chamber 2 of the scrubber 10, together with the exhaust gas, is gathered in the in absorbing liquid in the chamber 2, thus decomposing the malodorous substance in the absorbing liquid.

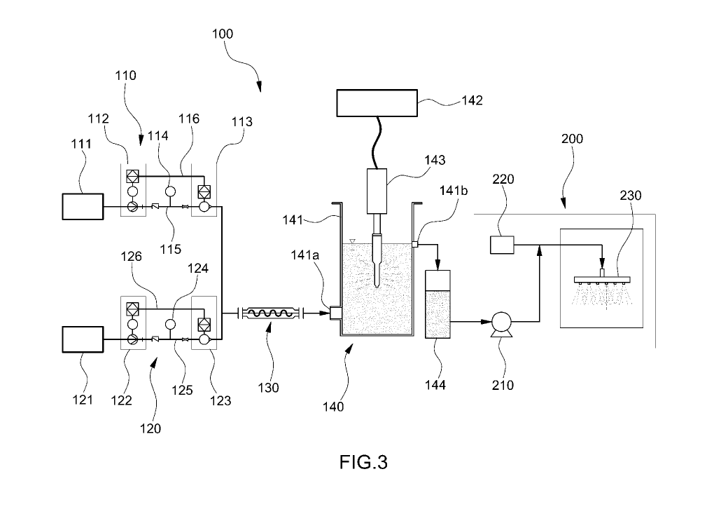

As shown in FIG. 3, the oxidizer generating device 100 includes a water quantitative feeder 110 for supplying a specific quantity of water, a hydrogen peroxide quantitative feeder 120 for supplying a specific quantity of hydrogen peroxide, a mixing device 130 for mixing the supplied water with the supplied hydrogen peroxide, and an ultrasonic wave reacting device 140 for reacting the mixture liquid introduced from the mixing device 130 with ultrasonic waves.

The water quantitative feeder 110 includes a water storing tank 111 for storing the water, a water quantitative pump 112 for feeding the water of a specific quantity from the water storing tank 111, and a water flow rate control valve 13 for adjusting and exhausting the flow rate of the water fed from the water quantitative pump 112.

Herein, a water pressure gauge 114 for measuring the pressure of the fed water is installed in a pipe 115 between the water quantitative pump 112 and the water flow rate control valve 113, and in addition to the pipe 115, a water return pipe 116 is installed to connect the water quantitative pump 112 and the water flow rate control valve 113.

A controller (not shown) is connected to the water quantitative pump 112, the water flow rate control valve 113, and the water pressure gauge 114 to control operations of one or both of the water quantitative pump 112 and the water flow rate control valve 113 according to a pressure signal (a water pressure signal input from the water pressure gauge 114) input to the controller in such a way to increase or reduce the flow rate of the water in the pipe 115.

For example, if the pressure of the water in the pipe 115 exceeds a predetermined pressure, according to a signal of the controller, the water flow rate control valve 113 exhausts the water corresponding to the predetermined pressure toward the mixing device 130, and circulates some water corresponding to the exceeding pressure toward the water quantitative pump 112 and returns the water through the water returning pipe 116.

The hydrogen peroxide quantitative feeder 120 includes a hydrogen peroxide storing tank 121 for storing hydrogen peroxide, a hydrogen peroxide quantitative pump 122 for feeding a specific quantity of hydrogen peroxide from the storing tank 121, and a hydrogen peroxide flow rate control valve 123 for adjusting the flow rate of hydrogen peroxide fed from the quantitative pump 122 and exhausting the flow-rate adjusted hydrogen peroxide.

Herein, a hydrogen peroxide pressure gauge 124 for measuring the pressure of the fed hydrogen peroxide is installed in a pipe 125 between the hydrogen peroxide quantitative pump 122 and the hydrogen peroxide flow rate control valve 123. In addition to the pipe 125, a hydrogen peroxide return pipe 126 is installed to connect the hydrogen peroxide quantitative pump 122 and the hydrogen peroxide flow rate control valve 123.

A controller (not shown) is connected to the hydrogen peroxide quantitative pump 122, the hydrogen peroxide flow rate control valve 123, and the hydrogen peroxide pressure gauge 124 to control operations of one or both of the hydrogen peroxide pump 122 and the hydrogen peroxide flow rate control valve 123 according to a pressure signal (a hydrogen peroxide pressure signal input from the hydrogen peroxide pressure gauge 124) input to the controller in such a way to increase or reduce the flow rate of the hydrogen peroxide in the pipe 125.

For example, if the pressure of the hydrogen peroxide in the pipe 125 exceeds a predetermined pressure, according to a signal of the controller, the hydrogen peroxide flow rate control valve 123 exhausts the hydrogen peroxide corresponding to the predetermined pressure toward the mixing device 130, and circulates some hydrogen peroxide corresponding to the exceeding pressure toward the hydrogen peroxide quantitative pump 122 and returns the hydrogen peroxide through the hydrogen peroxide returning pipe 126.

The mixing device 130 may be any well-known device capable of uniformly mixing the water supplied from the water quantitative feeder 110 with the hydrogen peroxide supplied from the hydrogen peroxide quantitative feeder 120.

The ultrasonic wave reacting device 140 includes a reaction vessel 141 for receiving the mixture liquid exhausted and supplied from the mixing device 130, an ultrasonic wave generating device 142 for generating ultrasonic waves, an ultrasonic wave rod 143 for delivering the ultrasonic waves generated by the ultrasonic wave generating device 142 to the mixture liquid in the reaction vessel 141, and an oxidizing water storing vessel 144 for temporarily storing oxidizing water generated by reacting the mixture liquid with the ultrasonic waves in the reaction vessel 141.

As an be seen in FIG. 3, the ultrasonic wave rod 143 supplies ultrasonic waves while its longitudinal lower end portion is dipped in the mixture liquid in the reaction vessel 141, such that hydrogen peroxide in the mixture liquid reacts with the ultrasonic waves in the reaction vessel 141, thus being transformed into an oxidizer (.OH).

To secure a proper reaction time which allows the mixture liquid introduced in the reaction vessel 141 to react with the ultrasonic waves supplied by the ultrasonic wave rod 143, an outlet 141b for exhausting the oxidizing water generated in the reaction vessel 141 is disposed in an upper portion of the reaction vessel 141, and an inlet 141a for receiving the mixture liquid exhausted from the mixing device 130 is disposed in a lower portion of the reaction vessel 141.

The oxidizing water storing vessel 144 is supplied with and temporarily stores the oxidizing water exhausted from the outlet 141b of the reaction vessel 141.

As shown in FIGS. 2 and 3, the oxidizer spray device 200 includes an oxidizing water quantitative pump 210 for feeding a specific quantity of oxidizing water from the oxidizing water storing vessel 144, a compressed air supply device 220 for supplying compressed air toward an oxidizing water spray nozzle 230, and the oxidizing water spray nozzle 230 supplied with oxidizing water fed from the oxidizing water quantitative pump 210 by the compressed air supplied from the compressed air supply device 220 to spray the oxidizing water in an atomized state to the exhaust gas.

Herein, the spray nozzle 230 is installed to spray the oxidizing water to the exhaust gas supplied to the scrubber 10 through a turbulent flow forming device 300, and for example, the spray nozzle 230 may be installed in a gas pipe 310 of the turbulent flow forming device 300.

The turbulent flow forming device 300 is intended to form a turbulent flow in the exhaust gas supplied to the chamber 2 of the scrubber 10, and may include the gas pipe 310 in which a two-step impeller 311 is installed, as shown in FIG. 2.

The turbulent flow forming device 300 causes the exhaust gas introduced to the scrubber 10 to form the turbulent flow, thereby increasing a probability of collision and reaction between the oxidizing water (including an oxidizer) supplied in an atomized state through the oxidizer spray device 200 and malodorous substances in the exhaust gas and thus effectively decomposing the malodorous substances of the exhaust gas.

The scrubber 10 includes the porous pall rings 5 installed in a multi-step form in the chamber 2 which receives a specific quantity of absorbing liquid, the spray nozzles 7 installed on an upper portion of the pall rings 5, the pump 3 for pumping the absorbing liquid received in the chamber 2 and supplying the absorbing liquid to the spray nozzles 7, and the demister 8 installed above the spray nozzles 7 to prevent minute absorbing liquid particles generated by the spray nozzles 7 from being exhausted to the outside air together with treated clean air.

Herein, the pall rings 5 are disposed on the respective support plates 4 installed in a multi-step form in the chamber 2.

Hereinafter, an operating state of the above-described system for pre-treating malodorous substances in the flushing pollution control facility will be described.

As mentioned previously, polluted air introduced to the chamber 2 of the scrubber 10, that is, exhaust gas first passes through the turbulent flow forming device 300 before introduced through the inlet 1 of the chamber 2.

The exhaust gas introduced to the gas pipe 310 of the turbulent flow forming device 300 flows while forming a turbulent flow by the multi-step impeller 311, and at this time, the oxidizing water in an atomized state is supplied from the oxidizer spray device 20, such that the exhaust gas is oxidized by the oxidizer (.OH) of the oxidizing water and is introduced to the chamber 2 in a state where malodorous substances thereof are decomposed.

The oxidizer generating device 100 for generating the oxidizing water mixes water supplied from the water quantitative supply device 110 with the hydrogen peroxide supplied from the hydrogen peroxide supply device 120 by means of the mixing device 130, and the generated mixture liquid is introduced to the reaction vessel 141 of the ultrasonic wave reacting device 140.

In this state, the ultrasonic waves generated by the ultrasonic wave generating device 142 are delivered to the mixture liquid in the reaction vessel 141 through the ultrasonic wave rod 143, such that the hydrogen peroxide (H₂O₂) in the mixture liquid reacting with the ultrasonic waves is transformed into hydroxyl radical (.OH), that is, the oxidizer, thus generating the oxidizing water including the oxidizer, and the generated oxidizing water is introduced to the oxidizing water storing vessel 144 through the outlet 141b of the reaction vessel 141.

The oxidizing water, after temporarily stored in the oxidizing water storing vessel 144, is fed by the oxidizing water quantitative pump 210 of the oxidizer spray device 200.

The oxidizer spray device 200 sprays the oxidizing water fed by the oxidizing water quantitative pump 210 to the exhaust gas in the gas pipe 310 of the turbulent flow forming device 300 by using the oxidizing water spray nozzle 230, such that the fed oxidizing water is supplied to the oxidizing water spraying nozzle 230 through the compressed air supplied by the compressed air supply device 220 and then is supplied in an atomized state to the exhaust gas in the gas pipe 310 through the oxidizing water spray nozzle 230.

The exhaust gas to which the atomized oxidizing water is sprayed is gas-phase reacted with the oxidizer (.OH) of the oxidizing water, such that the malodorous substances thereof are decomposed, and then the exhaust gas is introduced to the chamber 2 of the scrubber 10.

In other words, the oxidizer (.OH) of the oxidizing water supplied in the atomized state to the exhaust gas primarily decomposes the malodorous substances through gas-phase reaction, and the non-reacted oxidizer (.OH) secondarily decomposes the malodorous substances gathered by the absorbing liquid in the chamber 2 and thus existing in the absorbing liquid.

Herein, the water quantitative supply device 110 and the hydrogen peroxide quantitative supply device 120 may variably adjust a flow rate within a range of 0.1-1 l to properly adjust an oxidizing water injection quantity according to the concentration of malodorous substances in the exhaust gas.

Conditions for generating the oxidizing water including the oxidizer (.OH) may vary according to the concentration of malodorous substances in the exhaust gas, but when the concentration of phenols is 0.25 ppm, the conditions are as described below.

That is, for example, when the concentration of phenols is 0.25ppm, to generate oxidizing water necessary for pre-treating malodorous substances in exhaust gas, water of 0.8 l/min is supplied from the water quantitative supply device 110 and hydrogen peroxide of 0.2 l/min (a 35% water solution) is supplied is from the hydrogen peroxide quantitative supply device 120 and are mixed by the mixing device 130 to make mixture liquid, after which the mixture liquid is introduced to the reaction vessel 141 (reaction quantity of 1 l) of the ultrasonic wave reacting device 140 and is reacted with ultrasonic waves (20 kHz, 300 W) for 1 minute by the ultrasonic wave generating device 142 and the ultrasonic wave rod 143 to transform the hydrogen peroxide (H₂O₂) of the mixture liquid into the oxidizer (.OH). The remaining quantity of hydrogen peroxide in the generated oxidizing water (the quantity of hydrogen peroxide which is not transformed into the oxidizer) is less than 10% of an initial injection quantity.

As such, the system for pre-treating malodorous substances in a flushing pollution control facility according to the present invention primarily oxidizes malodorous substances in the exhaust gas and secondarily oxidizes malodorous substances in the absorbing liquid, thereby improving the malodor gathering capability of the mixture liquid and thus enhancing the malodor removing efficiency of the flushing pollution control facility.

That is, by enhancing the conventional flushing pollution control facility with the system for pre-treating malodorous substances according to the present invention, malodor from phenols, ammonia, Volatile Organic Compounds (VOCs), etc., and complex malodor can be reduced and the malodor gathering capability of the absorbing liquid is maintained by reducing the concentration of organic materials in the absorbing liquid, thereby extending a replacement period.

Therefore, according to the present invention, by extending a period of use of the absorbing liquid for the conventional flushing pollution control facility, cost reduction is possible and gaseous pollution substances can be properly treated, such that the enmity of local residents for the malodor can be prevented. Moreover, when compared to a Regenerative Thermal Oxidizer (RTO) facility, an initial investment and an operation cost can be cut down.

By applying the system for pre-treating malodorous substances according to the present invention to the conventional flushing pollution control facility, the malodorous substances in the exhaust gas are primarily oxidized and the malodorous substances in the absorbing liquid are secondarily oxidized to improve the malodor gathering capability of the absorbing liquid, thereby enhancing the malodor removing efficiency of the flushing pollution control facility.

By enhancing the conventional flushing pollution control facility with the system for pre-treating malodorous substances according to the present invention, the malodor gathering capability of the absorbing liquid is maintained with reduction of the concentration of organic materials in the absorbing liquid, such that a period of use of the absorbing liquid is extended, cost reduction is possible, and proper treatment of the gaseous pollution substance is achieved, thereby preventing the enmity of local residents for the malodor.

While an exemplary embodiment of the present invention has been described in detail, the protection scope of the present invention is not limited to the foregoing embodiment and it will be appreciated by those skilled in the art that various modifications and improvements using the basic concept of the present invention defined in the appended claims are also included in the protection scope of the present invention.

1. A system for pre-treating malodorous substances in a pollution control facility, the system comprising:
an oxidizer generating device for generating oxidizing water comprising an oxidizer;
a turbulent flow forming device for forming a turbulent flow in an exhaust gas introduced to the pollution control facility, the turbulent flow forming device comprising a gas pipe in which at least one impeller is installed so as to form a turbulent flow; and
an oxidizer spray device supplied with oxidizing water from the oxidizer generating device, the oxidizer spray device being configured and arranged to spray the oxidizing water in an atomized form onto or into the exhaust gas which flows in a turbulent flow state to the pollution control facility, wherein the oxidizer spray device comprises:
an oxidizing water quantitative pump for feeding a specific quantity of oxidizing water from the oxidizing water storing vessel;
a compressed air supply device for supplying compressed air; and
oxidizing water spray nozzles for atomizing the oxidizing water fed from the oxidizing water quantitative pump by the compressed air supplied from the compressed air supply device and for spraying the atomized oxidizing water into or onto the exhaust gas, wherein the oxidizing water spray nozzles are installed in the gas pipe of the turbulent flow forming device between the at least one impeller and an inlet of a scrubber;
wherein the exhaust gas is primarily oxidized by the oxidizer in the oxidizing water sprayed onto or into the exhaust gas, and absorbing liquid is subsequently contacted with the exhaust gas in the pollution control facility and is secondarily oxidized by non-reacted oxidizer from the oxidizing water to decompose malodorous substances.

2. The system of claim 1, wherein the oxidizer generating device comprises:
a water quantitative supply device for supplying a specific quantity of water;
a hydrogen peroxide quantitative supply device for supplying a specific quantity of hydrogen peroxide;
a mixing device for mixing the water and the hydrogen peroxide supplied from the water quantitative supply device and the hydrogen peroxide quantitative supply device to form a liquid mixture; and
an ultrasonic wave reacting device for reacting the liquid mixture with ultrasonic waves,
wherein the hydrogen peroxide in the liquid mixture is transformed into an oxidizer by the ultrasonic waves to generate the oxidizing water.

3. The system of claim 2, wherein the ultrasonic wave reacting device comprises:
a reaction vessel for receiving the liquid mixture from the mixing device;
an ultrasonic wave generating device for generating the ultrasonic waves in the ultrasonic wave reacting device;
an ultrasonic wave rod for delivering the ultrasonic waves generated in the ultrasonic wave generating device to the liquid mixture in the reaction vessel; and
an oxidizing water storing vessel for temporarily storing the oxidizing water.

4. The system of claim 1, wherein the oxidizer spray device comprises:
an oxidizing water quantitative pump for feeding a specific quantity of oxidizing water from the oxidizing water storing vessel ;
a compressed air supply device for supplying compressed air; and
oxidizing water spray nozzles for atomizing the oxidizing water fed from the oxidizing water quantitative pump by the compressed air supplied from the compressed air supply device and for spraying the atomized oxidizing water into or onto the exhaust gas.

5. The system of claim 1, wherein the turbulent flow forming device comprises a gas pipe in which at least one impellers are installed.

6. A method for pre-treating malodorous substances in a pollution control facility comprising:
flowing exhaust gas through a passageway to a pollution control facility;
forming a turbulent flow in the exhaust gas in the passageway prior to introduction to the pollution control facility;
spraying atomized oxidizing water onto or into the exhaust gas as the exhaust gas flows in a turbulent flow state to the pollution control facility to thereby primarily oxidize the exhaust gas.
